(19) United States
(12) Patent Application Publication
(10) Pub. No.: US 2026/0240120 A1
(43) Pub. Date: Aug. 20, 2026

(54) METHOD OF INDIVIDUAL IDENTIFICATION OF ANIMAL AND NON-TRANSITORY COMPUTER-READABLE STORAGE MEDIUM STORING COMPUTER PROGRAM

(71) Applicant: SEIKO EPSON CORPORATION, TOKYO (JP)

(72) Inventors: Naoki HAGIHARA, Shiojiri-shi (JP); Ryoki WATANABE, Matsumoto-shi (JP); Hikaru KURASAWA, Matsumoto-shi (JP)

(21) Appl. No.: 19/542,722

(22) Filed: Feb. 18, 2026

(30) Foreign Application Priority Data
Feb. 18, 2025 (JP) 2025-023905

(51) Int. Cl. A01K 29/00; G06T 7/10; G06T 7/50; G06V 10/26; G06V 10/74; G06V 10/82; G06V 40/10

(52) U.S. Cl. CPC A01K 29/005; G06T 7/10; G06T 7/50; G06V 10/26; G06V 10/761; G06V 10/82; G06V 40/10; G06T 2207/10028; G06V 2201/07

(57) ABSTRACT

A method of the present disclosure includes: (a) acquiring p-th type images from a first type image to a P-th type image with respect to a backside of an animal, where P is an integer no smaller than2, and p is an ordinal number from 1 to P; (b) obtaining P types of p-th type embedding vectors by obtaining the p-th type embedding vectors from the p-th type images using a p-th deep metric learning model out of P deep metric learning models; (c) calculating distances between P types of p-th type registered embedding vectors and the P types of p-th type embedding vectors using registration data including the P types of p-th type registered embedding vectors generated in advance with respect to each of a plurality of registered individuals; and (d) determining which of the plurality of registered individuals is the animal using the distances.

The present application is based on, and claims priority from JP Application Serial Number 2025-023905, filed February 18, 2025, the disclosure of which is hereby incorporated by reference herein in its entirety.

### BACKGROUND

### 1. Technical Field

The present disclosure relates to a method of individual identification of an animal and a non-transitory computer-readable storage medium storing a computer program.

### 2. Related Art

JP-A-2022-48464 discloses a technique for collating cow muzzle pattern images. In this related art, the muzzle pattern image is collated by extracting the muzzle pattern image from a face image of a cow, obtaining a feature vector of the muzzle pattern image using a neural network for classifying the muzzle pattern image, and calculating the similarity between that feature vector and a known feature vector.

JP-A-2022-48464 is an example of the related art.

However, in the related art, a face image having such high-resolution that a fine structure of the muzzle pattern can be discriminated is required, and there is a problem that it is difficult to acquire such a face image. For example, it is difficult to stop a movement of a cow that is continuously walking in order to take an image of that cow. Such a problem is not limited to individual identification of cows but is common to individual identification of other animals such as pigs. Therefore, there is a demand for a technique capable of performing the individual identification using other features than the muzzle pattern.

### SUMMARY

According to a first aspect of the present disclosure, a method of performing individual identification of an identification target animal is provided. This method includes: (a) acquiring p-th type target images from a first type target image to a P-th type target image with respect to a backside of the identification target animal, where P is an integer no smaller than 2, and p is an ordinal number from 1 to P; (b) obtaining P types of p-th type embedding vectors by obtaining the p-th type embedding vectors from the p-th type target images using a p-th deep metric learning model out of P deep metric learning models; (c) calculating distances between P types of p-th type registered embedding vectors and the P types of p-th type embedding vectors using registration data including the P types of p-th type registered embedding vectors generated in advance with respect to each of a plurality of registered individuals; and (d) determining which of the plurality of registered individuals is the identification target animal using the distances.

According to a second aspect of the present disclosure, there is provided a non-transitory computer-readable storage medium storing a computer program configured to make a processor execute processing of individual identification of an identification target animal. This computer program makes the processor execute the processing including: (a) acquiring p-th type target images from a first type target image to a P-th type target image with respect to a backside of the identification target animal, where P is an integer no smaller than 2, and p is an ordinal number from 1 to P; (b) obtaining P types of p-th type embedding vectors by obtaining the p-th type embedding vectors from the p-th type target images using a p-th deep metric learning model out of P deep metric learning models; (c) calculating distances between P types of p-th type registered embedding vectors and the P types of p-th type embedding vectors using registration data including the P types of p-th type registered embedding vectors generated in advance with respect to each of a plurality of registered individuals; and (d) determining which of the plurality of registered individuals is the identification target animal using the distances.

### BRIEF DESCRIPTION OF THE DRAWINGS

FIG. 1 is a block diagram showing a configuration of an individual identification system.

FIG. 2 is a flowchart showing a procedure of learning of a deep metric learning model and generation of registration data.

FIG. 3 is a flowchart showing a detailed procedure of step S20.

FIG. 4 is a diagram illustrating the contents of generation processing of target images in step S20.

FIG. 5 is a diagram illustrating an example of the registration data.

FIG. 6 is a flowchart showing a procedure of individual identification processing in a first embodiment.

FIG. 7 is a diagram illustrating an example of embedding vectors calculated in the individual identification processing.

FIG. 8 is a diagram illustrating an example of a distance between the embedding vector and a registered embedding vector.

FIG. 9 is a diagram illustrating the contents of distance calculation in the first embodiment.

FIG. 10 is a diagram illustrating an example of a p-th type distance representative value and an integrated distance.

FIG. 11 is a flowchart showing a procedure of registration update processing.

FIG. 12 is a flowchart showing a procedure of individual identification processing in a second embodiment.

FIG. 13 is a diagram illustrating the contents of distance calculation in the second embodiment.

FIG. 14 is a flowchart showing a procedure of individual identification processing in a third embodiment.

FIG. 15 is a diagram illustrating the contents of distance calculation in the third embodiment.

FIG. 16 is a diagram illustrating an example of registration data in a fourth embodiment.

FIG. 17 is a diagram illustrating an example of a composite embedding vector used in the fourth embodiment.

FIG. 18 is a diagram illustrating the contents of generation processing of target images in a fifth embodiment.

### DESCRIPTION OF EMBODIMENTS

### A. First Embodiment

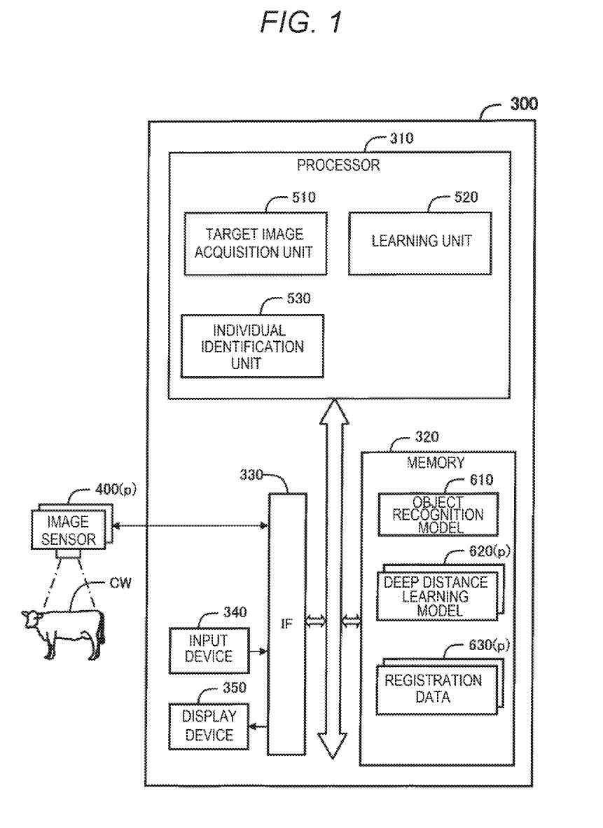

FIG. 1 is a diagram illustrating a configuration of an individual identification system according to a first embodiment. This individual identification system includes an information processing apparatus 300 and a plurality of image sensors 400(p). In the present embodiment, a processing target of individual identification is a cow CW. However, other animals such as pigs, dogs, and cats may be used as the processing target instead of cows.

The image sensor 400(p) is a camera that captures an image of the cow CW that is a target of individual identification processing. Each of the image sensors 400(p) is preferably installed so as to capture an image of a backside of the cow CW from above the cow CW. As the image sensor 400(p), a video camera that captures a moving image may be used, or a still image camera that captures a still image may be used. Further, as the image sensor 400(p), one or more of various sensors exemplified below can be used.

### (1) Depth Sensor

By using a depth image captured by a depth sensor, the individual identification can be performed based on unevenness of a backside of a cow.

### (2) RGB Sensor (Color Image Sensor)

By using a color image captured by an RGB sensor, the individual identification can be performed based on a monochrome pattern which is a mottled pattern on a backside of a cow. When there is dirt on the backside of the cow, the color image changes, and therefore, there is a possibility that erroneous recognition occurs when the individual identification is performed using only the RGB sensor. Meanwhile, since the depth image captured by the depth sensor is not affected by dirt on a backside of a cow, there is an advantage that the possibility of the erroneous recognition due to the dirt is low.

### (3) Spectroscopic Sensor

By using a spectral image captured by a spectroscopic sensor, the individual identification can be performed based on monochrome patterns which are mottled patterns of respective wavelengths of a backside of a cow.

### (4) Thermosensor

By using a thermo-image captured by a thermosensor, the individual identification can be performed based on an intensity distribution of an infrared ray on a backside of a cow. The intensity distribution of the infrared ray on a backside of a cow is an image reflecting that the degree of scattering of the infrared ray changes depending on the length of the hair and that the distance changes due to the unevenness and the degree of diffusion of the infrared ray changes.

As the plurality of image sensors 400(p), a combination of different image sensors or a combination of the image sensors of same type can be used. When a combination of the image sensors of the same type is used, it is preferable to set the plurality of image sensors different in at least one attribute such as an installation angle or a field angle from each other. In the plurality of image sensors 400(p), it is preferable that relative positions of respective sensor coordinate systems are known and a coordinate transformation matrix related to any two sensor coordinate systems is known.

The number P of the image sensors 400(p) is an integer no smaller than 2. In the first embodiment, P=2 is set, and a moving image of the backside of the cow CW is captured using two image sensors 400, that is, the depth sensor and the RGB sensor. It is preferable that the depth sensor and the RGB sensor have substantially the same imaging region and are configured to be able to capture images at the same imaging timing. For example, one RGBD sensor including the depth sensor and the RGB sensor can be used as the image sensor 400(p).

The information processing apparatus 300 executes the individual identification of the cow CW using an image that is related to the backside of the cow CW and is captured by the image sensor 400(p). The information processing apparatus 300 includes a processor 310, a memory 320, an interface circuit 330, and an input device 340 and a display device 350 coupled to the interface circuit 330. The image sensor 400(p) is also coupled to the interface circuit 330. The processor 310 has not only a function of executing processing described in detail below, but also a function of displaying data obtained by that processing and data generated in the process of that processing on the display device 350. The information processing apparatus 300 can be realized by a computer such as a personal computer.

The processor 310 has functions of a target image acquisition unit 510, a learning unit 520, and an individual identification unit 530. The target image acquisition unit 510 acquires a plurality of target images from a backside image captured by the image sensor 400(p). The learning unit 520 executes distance learning of P deep metric learning models 620(p). The individual identification unit 530 executes the individual identification of the cow CW using the deep metric learning models 620(p) having been learned. The functions of these units are realized by the processor 310 executing a computer program stored in the memory 320. However, some of these functions may be implemented by a hardware circuit. The processor in the present disclosure is a term including such a hardware circuit. Further, one or more processors that execute the various types of processing may be processors provided to one or more remote computers coupled via a network.

The similarity may be used as the distance learned by the deep metric learning model 620(p). The high similarity corresponds to a small distance. That is, "small distance" is equivalent to "high similarity." In the following description, "distance" is used as a term including "similarity."

The memory 320 stores an object recognition model 610, the P deep metric learning models 620(p), and P pieces of registration data 630(p). The object recognition model 610 is a machine learning model that takes an image of the cow CW as an input and a plurality of key points that are geometric feature points of the cow CW as an output. In the present embodiment, it is assumed that the object recognition model 610 has been learned. The object recognition model 610 can also be referred to as a "feature recognition model."

The deep metric learning model 620(p) is a machine learning model that takes the image of the cow CW as an input and an embedding vector as an output. The character p is an ordinal number from 1 to P representing the order of the deep metric learning model 620(p). The embedding vector is also referred to as a "feature vector." The deep metric learning model 620(p) can be configured using, for example, FaceNet.

In the following description, a reference symbol attached with (p) at the foot thereof means that the reference symbol corresponds to the ordinal number p of the deep metric learning model 620. Further, a prefix of "p-th type" also means that the prefix corresponds to the ordinal number p of the deep metric learning model 620.

The registration data 630(p) is a database in which an individual ID and a plurality of p-th type embedding vectors obtained using the p-th deep metric learning model 620(p) are registered for each of a plurality of registered individuals. The individual ID is, for example, an individual identification number displayed on an earmark of the cow CW. The p-th type embedding vector registered in p-th registration data 630(p) is referred to as a "p-th type registered embedding vector." An image of each registered individual may be registered in the registration data 630(p) in addition to the p-th type registered embedding vector.

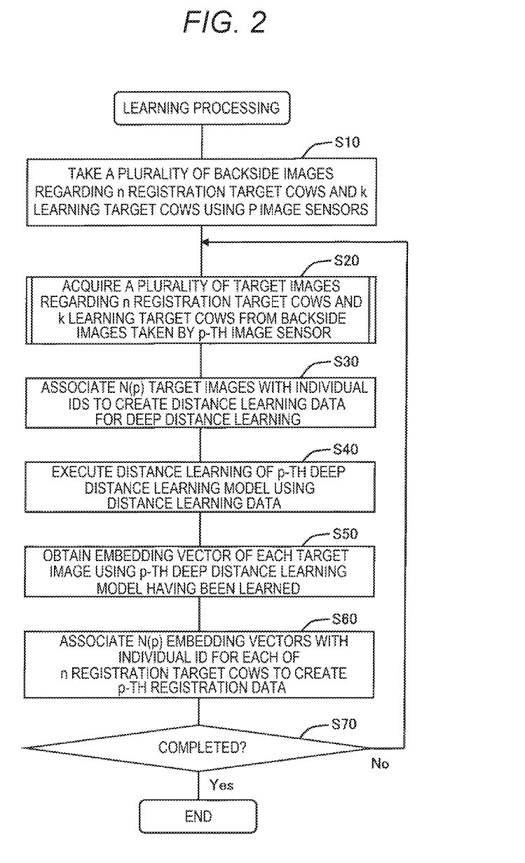

FIG. 2 is a flowchart illustrating a procedure of learning of the deep metric learning model 620(p) and generation of the registration data 630(p). In the following description, it is assumed that n is an integer no smaller than 2 and n registration target cows are registered in the registration data 630(p). In the present embodiment, the n registration target cows are the same in breed.

In step S10, the target image acquisition unit 510 captures a plurality of backside images related to the backside for each of the n registration target cows and k learning target cows using the P image sensors 400(p). Here, n and k are each an integer no smaller than 2. This image capturing can be performed when, for example, each cow sequentially passes below the image sensors 400(p). When a moving image is captured, a plurality of frame images is selected as the backside images from the moving image. This selection can be performed by, for example, automatically selecting the frame image including a rear portion of the registration target cow using an annotation tool. Alternatively, an operator may manually perform the selection.

In step S20, the target image acquisition unit 510 acquires a plurality of target images related to the backside for each of the n registration target cows and the k learning target cows from the backside images captured by the p-th image sensor 400(p). The "learning target cow" means a cow to be used to generate learning data of the deep metric learning model 620(p). In the deep distance learning, it is desirable to perform learning of the neural network using learning data different from the registration data 630(p) from the viewpoint of robustness. Further, it is desirable to generate the learning data so as to include more data than the registration data 630(p). Therefore, k is preferably set to a number greater than n. However, the learning target cows may include the registration target cow as a part thereof. Further, by setting n=k, the same cow may be used as both the learning target cow and the registration target cow. The number of target images acquired from each cow may be set to a constant value N(p), or may be set to a number different by individual cow. Here, N(p) is an integer that is no smaller than 1 and is defined with respect to the ordinal number p, but is preferably no smaller than 2. In addition, N(p) may be a constant value that does not depend on the ordinal number p.

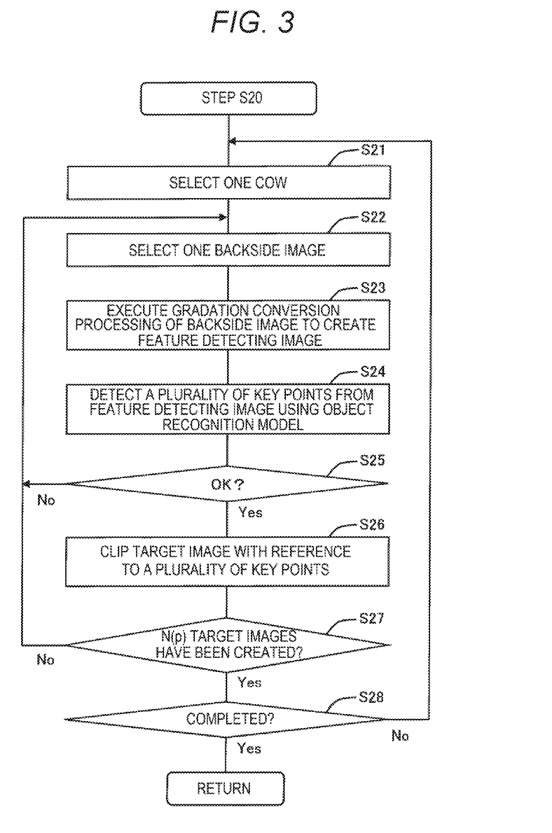

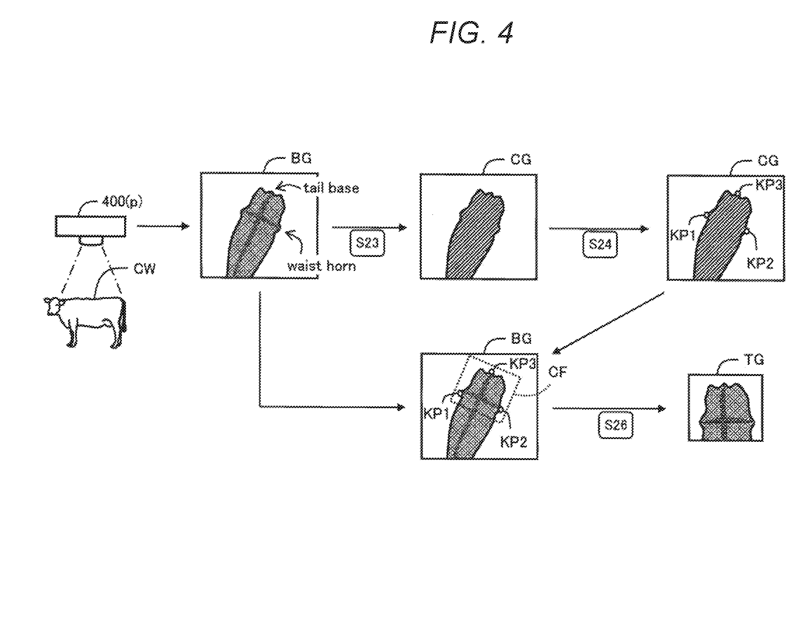

FIG. 3 is a flowchart showing a detailed procedure of step S20, and FIG. 4 is a diagram illustrating the processing contents thereof. In FIG. 4, a depth sensor is used as the image sensor 400(p). In FIG. 4, some of step numbers are added.

A backside image BG shown in FIG. 4 includes the rear portion of the cow CW including a waist horn and the base of the tail. Since the individual cow CW is characterized by a shape of the rear portion of the cow CW, the backside image BG preferably includes the rear portion of the cow CW including the waist horn and the base of the tail.

In step S21, the target image acquisition unit 510 selects one cow as a processing target from the n registration target cows and the k learning target cows. In step S22, the target image acquisition unit 510 selects one backside image BG as a processing target from a plurality of backside images BG. In step S23, the target image acquisition unit 510 generates a feature detecting image CG by executing gradation conversion processing of the backside image BG. The gradation conversion processing is processing of extracting a gradation range in which a contour of the cow is easily detected out of all gradations of the backside image BG and converting the backside image BG into an image having a predetermined number of gradations. For example, when the backside image BG, which is a depth image, is an image having 2400 gradations, the feature detecting image CG may be generated by extracting 512 intermediate gradations from the backside image BG and compressing the gradations to 256 gradations. However, step S23 may be omitted.

In step S24, the target image acquisition unit 510 detects a plurality of key points from the feature detecting image CG using the object recognition model 610. In the example of FIG. 4, two key points KP1, KP2 are detected at the position of the waist horn of the cow CW, and one key point KP3 is detected at the position of the base of the tail. These key points KP1 to KP3 are feature points present on an outline of the cow CW. The object recognition model 610 is a machine learning model that takes the feature detecting image CG as an input and the plurality of key points KP1 to KP3 as an output. However, the object recognition model 610 may be configured to recognize a key point representing another position. The object recognition model 610 can be configured using, for example, DeepLabCut or ResNet, which is a deep learning model. The object recognition model 610 may be configured using another machine learning model.

In step S25, the target image acquisition unit 510 determines whether a predetermined number of key points KP1 to KP3 are detected. When the predetermined number of key points KP1 to KP3 are not detected, the process returns to step S22, a new backside image BG is selected as the processing target, and the processing in step S23 and subsequent steps is executed once again. When the predetermined number of key points KP1 to KP3 are detected, the process proceeds to step S26.

In step S26, the target image acquisition unit 510 clips a target image TG from the backside image BG with reference to the plurality of key points KP1 to KP3. The target image TG is an image including a characterizing portion of the backside of the cow. In the example in FIG. 4, in the backside image BG, a state in which a clipping frame CF with reference to the key points KP1 to KP3 is set, and the target image TG clipped in accordance with the clipping frame CF are drawn. On this occasion, it is preferable to execute a rotation or a size change of the target image TG so that a direction or a size of the waist horn of the cow CW in the target image TG becomes a desired value. Further, pixel values of the target image TG may be normalized. This normalization is processing of, for example, normalizing the pixel value as a minimum depth value as 1.0, and the pixel value as a maximum depth value as 0, and further, converting the pixel values in a range of 0 to 1.0 into the gradations of 0 to 255. Note that steps S23 to S26 may be omitted to thereby use the backside image BG directly as the target image TG.

In step S27, the target image acquisition unit 510 determines whether N(p) target images TG have been generated for one cow. When the N(p) target images TG have not been generated, the process returns to step S22, a new backside image BG is selected as the processing target, and the processing in step S22 and subsequent steps is executed once again. When the N(p) target images TG have been generated, the process proceeds to step S28.

In step S28, the target image acquisition unit 510 determines whether the processing has been completed for all the n registration target cows and the k learning target cows. When the processing has not been completed for all the cows, the process returns to step S21, a new cow is selected as the processing target, and the processing in step S22 and subsequent steps is executed once again. When the processing is completed for all the cows, the processing in step S20 related to the p-th image sensor 400(p) ends.

Note that in the processing in FIG. 3 related to the image captured by the RGB sensor, similarly to the processing related to the image captured by the depth sensor, it is possible to detect the plurality of key points KP1 to KP3 from the backside image BG captured by the RGB sensor and set the clipping frame CF with reference to these key points. Alternatively, it is possible to convert the plurality of key points KP1 to KP3 detected from the backside image BG by the depth sensor into coordinates of the sensor coordinate system of the RGB sensor using a coordinate conversion matrix between the depth sensor and the RGB sensor, and set the clipping frame CF based on the key points KP1 to KP3 after the coordinate conversion. The latter method is particularly useful when the depth sensor and the RGB sensor are configured as a single RGBD sensor.

In step S30 in FIG. 2, the learning unit 520 generates distance learning data for the deep distance learning by associating N(p) target images TG acquired for each learning target cow with the individual ID. In step S40, the learning unit 520 executes the distance learning of the p-th deep metric learning model 620(p) using the distance learning data. This distance learning is processing of adjusting internal parameters of the deep metric learning model 620(p) such that the distance is short in the same individual and the distance is long in different individuals with respect to the p-th type embedding vectors output from the deep metric learning model 620(p). As the distance of the p-th type embedding vectors, for example, a Euclidean distance between the vectors may be used, or an angle between the vectors may be used.

In step S50, the learning unit 520 sequentially inputs N(p) target images TG related to each registration target cow to the p-th deep metric learning model 620(p) that has been learned, and obtains the p-th type embedding vector for each of the target images TG. As a result, N(p) p-th type embedding vectors are obtained for each registration target cow. In step S60, the learning unit 520 generates the p-th registration data 630(p) by associating N(p) p-th type embedding vectors with the individual ID for each of the n registration target cows.

In step S70, the learning unit 520 determines whether the processing has been completed for all the cases where the ordinal number p is 1 to P. When the processing is completed, the processing in FIG. 2 ends. When the processing is not completed, the process returns to step S20, and the processing in steps S20 to S70 is executed once again using the next value of the ordinal number p.

By performing the learning processing in FIG. 2 described above, the P deep metric learning models 620(p) having been learned and P registration data 630(p) related to the n registration target cows are obtained. In the following description, the registration target cow is referred to as a "registered individual." Further, the p-th type embedding vector registered in the registration data 630(p) is referred to as a "p-th type registered embedding vector."

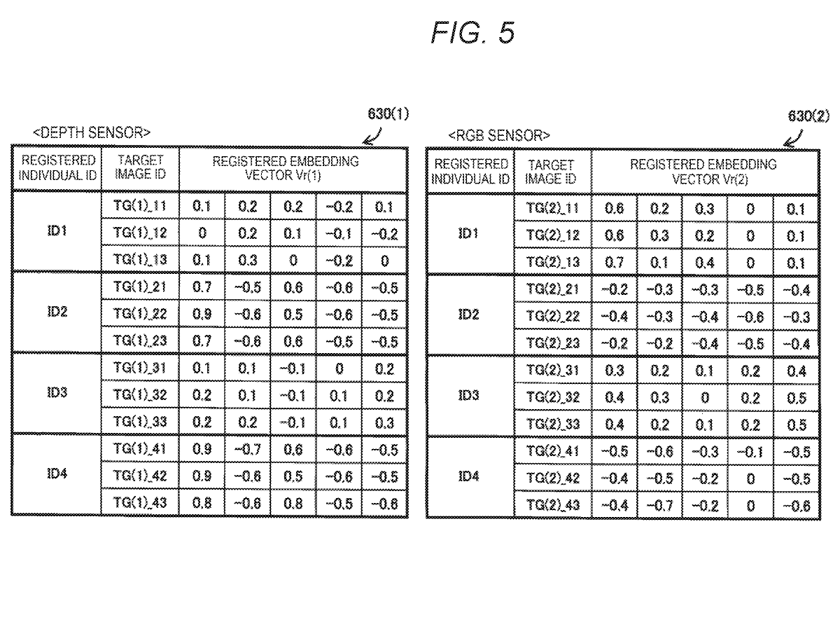

FIG. 5 is a diagram illustrating an example of the registration data 630(p). In this example, two image sensors, that is, the depth sensor and the RGB sensor are used as the P image sensors 400(p). Further, the number n of registration target cows is 4, and the number N(p) of target images TG is N(1)=N(2)=3. The registration data 630(p) includes first registration data 630(1) generated using the depth sensor and second registration data 630(2) generated using the RGB sensor. In the first registration data 630(1), registered embedding vectors Vr(1) related to three target images TG are registered for each of the four registered individuals. In this example, the registered embedding vectors Vr(1) are each a five-dimensional vector having five elements. The individual IDs of the four registered individuals are ID1 to ID4. Further, image IDs different from each other are assigned to the three target images TG obtained for each individual. However, the image IDs are not required to be registered. Also in the second registration data 630(2), registered embedding vectors Vr(2) related to three target images TG are registered for each of the four individuals that are the same as in the first registration data 630(1). Normally, a larger number of registered embedding vectors Vr(p) are registered for each registered individual, but in FIG. 5, the number of registered embedding vectors Vr(p) is reduced for the sake of convenience of illustration.

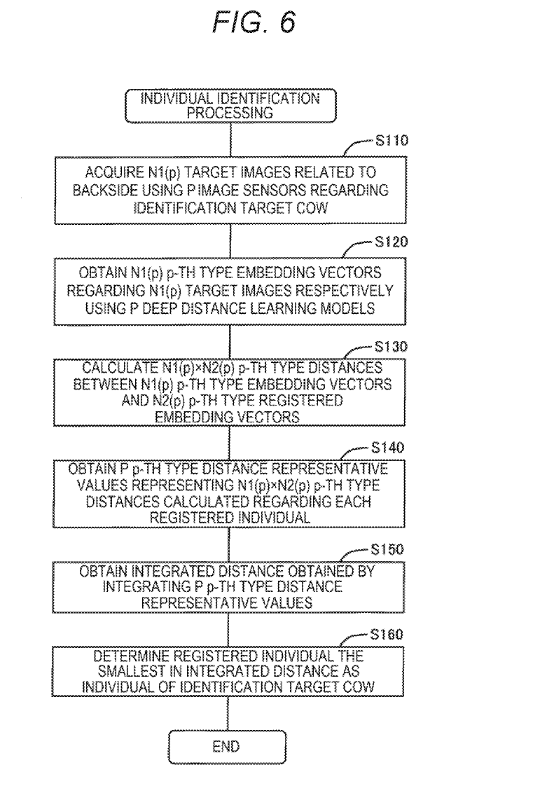

FIG. 6 is a flowchart illustrating a procedure of the individual identification processing. It is preferable that the individual identification processing is periodically performed on, for example, all cows reared in the same farm as identification target cows.

In step S110, the individual identification unit 530 acquires N1(p) target images TG related to the backside using each of the P image sensors 400(p) regarding one identification target cow. Here, N1(p) is an integer no smaller than 1 defined with respect to the ordinal number p. The value of N1(p) may be set to a value equal to the number of p-th type registered embedding vectors related to each of the registered individuals registered in the registration data 630(p), or may be set to a value different therefrom. In addition, N1(p) may be set to the number of target images TG that are acquired at that time regarding the identification target cow instead of a value set in advance. In the following description, the number of p-th type registered embedding vectors related to each registered individual is referred to as "N2(p)" to be distinguished from the number N1(p) of target images TG of the identification target cow. The integer N2(p) is the same as the integer N(p) used in FIGS. 2 and 3, and is an integer no smaller than 2. In the example in FIG. 5, the number N2(p) of p-th type registered embedding vectors is 3. The specific processing contents of step S110 is the same as generation processing of the target image TG for the registration target cow described in FIGS. 3 and 4.

In step S120, the individual identification unit 530 obtains N1(p) p-th type embedding vectors regarding the N1(p) target images TG using each of the P deep metric learning models 620(p) having been learned.

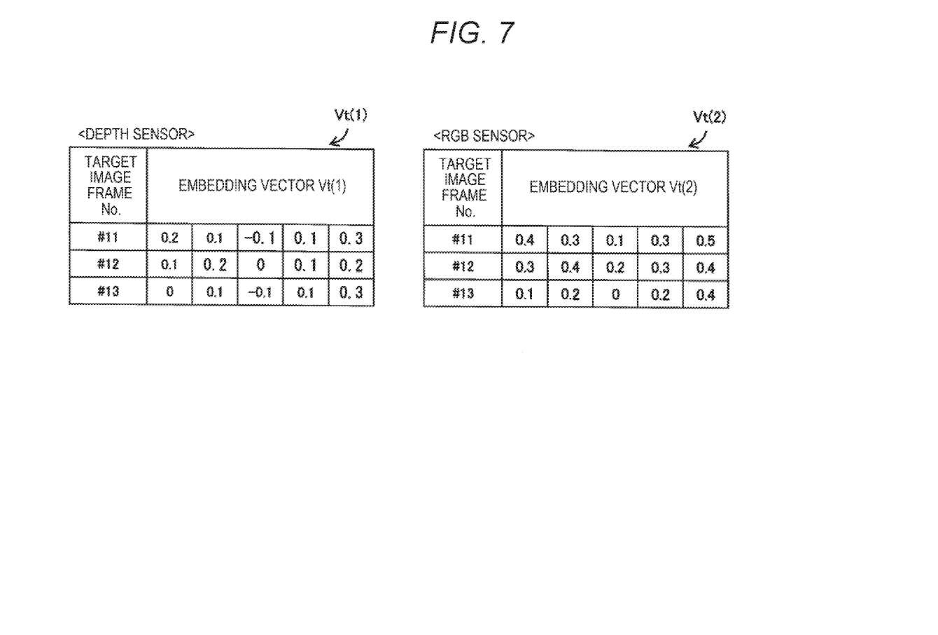

FIG. 7 is a diagram illustrating an example of an embedding vector calculated in the individual identification processing. In this example, the number N1(p) of target images TG is N1(1)=N1(2)=3. That is, a first type embedding vector Vt(1) and a second type embedding vector Vt(2) are calculated related to each of three target images obtained for the identification target cow. The p-th type embedding vector Vt(p) is a vector of the same dimension as the p-th type registered embedding vector Vr(p) shown in FIG. 5.

In step S130, the individual identification unit 530 calculates a p-th type distance that is a distance between the N1(p) p-th type embedding vectors and the N2(p) p-th type registered embedding vectors related to each of the registered individuals. As a result, N1(p)×N2(p) p-th type distances are calculated for each registered individual. In addition, since there are n registered individuals, n×N1(p)×N2(p) p-th type distances are calculated using the p-th deep metric learning model 620(p) regarding one identification target cow. That is, n×N1(p)×N2(p) p-th type distances are calculated from the images captured by each of the image sensors 400(p).

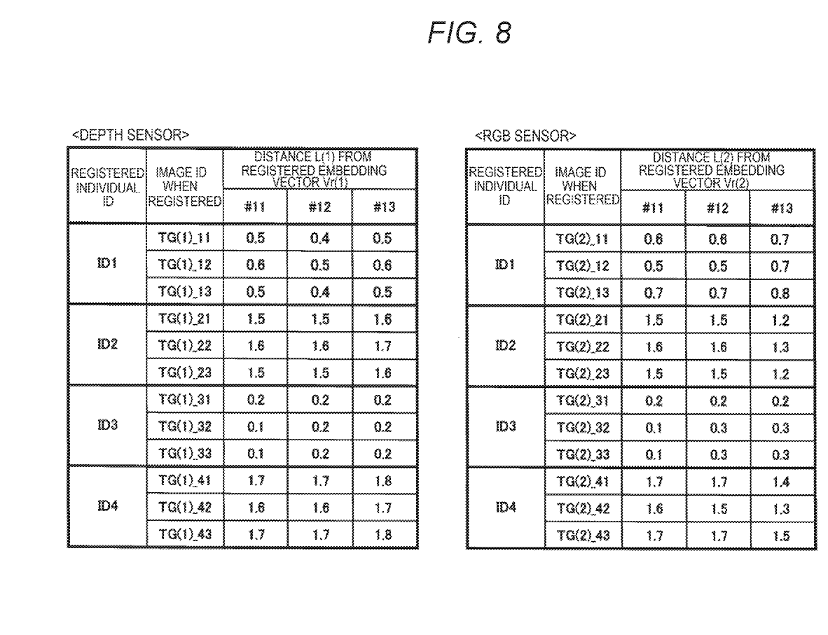

FIG. 8 is a diagram illustrating an example of a distance between the embedding vector and the registered embedding vector. Regarding the registered embedding vector Vr(p) shown in FIG. 5, n=4 and N2(p)=3 are obtained, and regarding the embedding vector Vt(p) shown in FIG. 7, N1(p)=3 is obtained. Therefore, 36 p-th type distances L(p) are calculated from the images captured by each of the image sensors 400(p) related to one identification target cow.

In step S140, the individual identification unit 530 obtains a p-th type distance representative value representing N1(p)×N2(p) p-th type distances calculated for each registered individual. The p-th type distance representative value is determined by, for example, any of the following methods.

### Determination Method DM1 of p-th Type Distance Representative Value

By selecting M(p) p-th type distances from the smallest out of the N1(p)×N2(p) p-th type distances and then calculating an average value of the M(p) p-th type distances, the p-th type distance representative value is obtained. Here, M(p) is an integer that is defined with respect to the ordinal number p and is no smaller than 2 and no greater than N1(p)×N2(p), and is preferably an integer smaller than N1(p)×N2(p). The value itself of M(p) may be directly set by a user, or the value of M(p) may be substantively set by designating the ratio of M(p) to N1(p)×N2(p). When M(p) is no smaller than 2, it is preferable for the integers N1(p), N2(p) to be set such that N1(p)×N2(p) is no smaller than 3.

### Determination Method DM2 of p-th Type Distance Representative Value

The minimum value of the N1(p)×N2(p) p-th type distances is selected as the p-th type distance representative value.

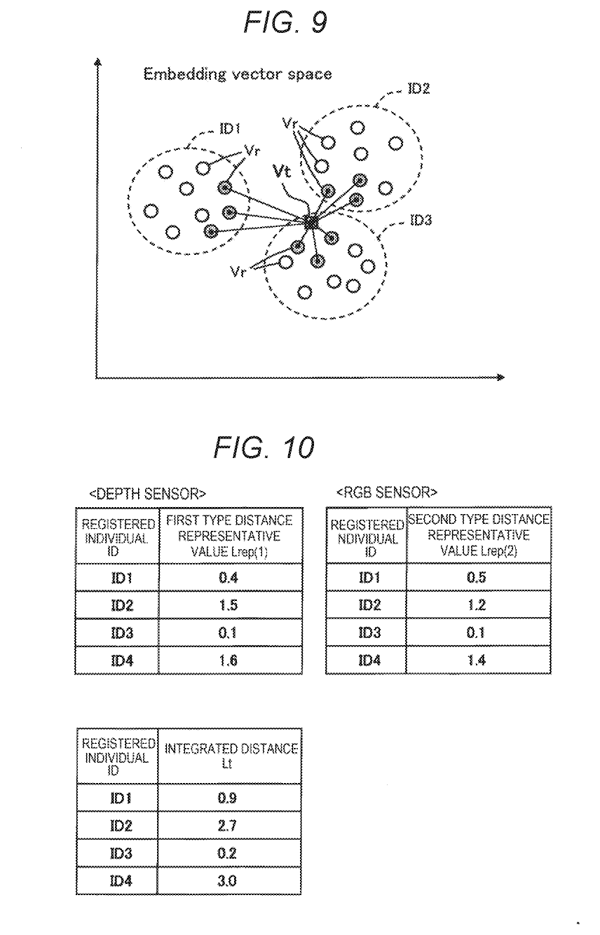

FIG. 9 is a diagram illustrating the contents of distance calculation by the determination method DM1 described above. Here, there is shown an example in which n=3, N1(p)=1, N2(p)=9, and M(p)=3 are assumed in one p-th embedding vector space. In the drawing, ID1 to ID3 are individual IDs corresponding to three registered individuals, and circles belonging to an area surrounded by a broken line indicate positions of registered embedding vectors Vr of each of the registered individuals. Further, a rectangle indicates a position of an embedding vector Vt obtained for the identification target cow. Hatched circles indicate M(p) registered embedding vectors Vr each having a small distance from the embedding vector Vt of the identification target cow. In this example, since M(p)=3 is assumed, three distances from the smallest are selected for each of the registered individuals. In the first embodiment, M(p)=3 is used, and the p-th type distance representative value is determined in accordance with the determination method DM1.

In step S150, the individual identification unit 530 obtains an integrated distance obtained by integrating P p-th type distance representative values. As the integrated distance, it is possible to use a value proportional to a calculation result of a calculation such as a simple average, a weighted average, a simple addition, or a weighted addition of the P p-th type distance representative values. When the weighted average or the weighted addition is used, it is preferable to set weighting coefficients for the P p-th type distance representative values in advance. In addition, scores of 1 point, 2 points, ... may be given in ascending order of the P p-th type distance representative values, and a value proportional to an average value or an addition value of the scores may be calculated as the integrated distance. The "value proportional to something" means a value obtained by multiplying that thing by a non-zero positive coefficient. In the first embodiment, the simple average of the P p-th type distance representative values is used as the integrated distance.

In step S160, the individual identification unit 530 determines that the registered individual the smallest in integrated distance is the individual of the identification target cow. As a result, the individual ID of that registered individual is determined to be the individual ID of the identification target cow.

FIG. 10 is a diagram illustrating an example of the p-th type distance representative values and the integrated distances. In this example, for each of the registered individuals, a first type distance representative value Lrep(1) and a second type distance representative value Lrep(2) are calculated using M(p)=3 in accordance with the determination method DM1 described above. Further, an integrated distance Lt for each of the registered individuals is calculated by the simple addition of the first type distance representative value Lrep(1) and the second type distance representative value Lrep(2). In this example, since the integrated distance Lt of the registered individual having the individual ID of ID3 is the smallest among the four registered individuals, this registered individual is determined to be the identification target cow.

According to the processing in FIGS. 9 and 10 described above, the individual of the identification target cow can be determined from the N1(p)×N2(p) p-th type distances related to each of the registered individuals. In particular, in the first embodiment, since the p-th type distance representative value representing the N1(p)×N2(p) p-th type distances is obtained, then the integrated distance obtained by integrating the P p-th type distance representative values is obtained, and then the registered individual the smallest in integrated distance is determined as the individual of the identification target cow, the individual of the identification target cow can correctly be determined.

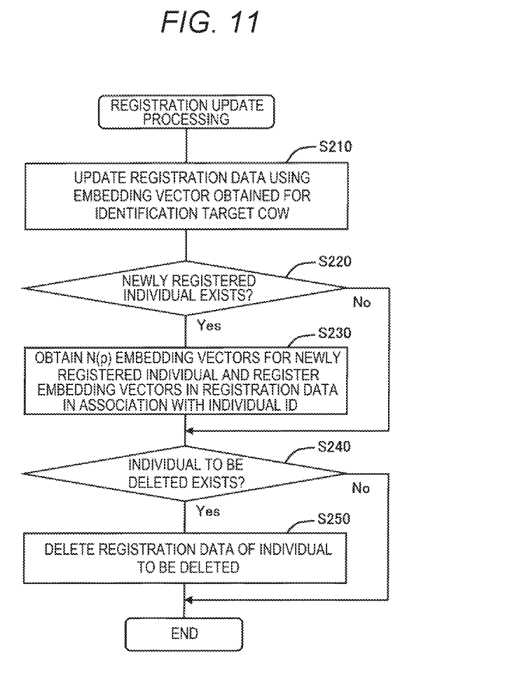

FIG. 11 is a flowchart illustrating a procedure of registration update processing. This registration update processing is preferably executed periodically, and is preferably executed, for example, once a day.

In step S210, the individual identification unit 530 updates the registration data 630(p) using the embedding vectors Vt obtained for the identification target cow in the processing in FIG. 9. For example, when N1(p)=N2(p) is true, that is, when the number N1(p) of embedding vectors Vt obtained for the identification target cow is equal to the number N2(p) of registered embedding vectors Vr related to each of the registered individuals in the registration data 630(p), the registration data 630 may be updated so that the N(p) registered embedding vectors Vr are replaced with new N(p) embedding vectors Vt. Alternatively, the registration data 630 may be updated so as to add N1(p) embedding vectors Vt obtained for the identification target cow without discarding the old registered embedding vector Vr.

Further, when q is defined as an integer no smaller than 2, when the number N2(p) of registered embedding vectors Vr is equal to q×N1(p), the registration data 630 may be updated so as to discard the oldest N1(p) registered embedding vectors Vr, and add N1(p) embedding vectors Vt newly obtained for the identification target cow. In this way, the registration data 630(p) can be updated so as to always include the latest q×N1(p) registered embedding vectors Vr. Further, instead of updating the registration data 630(p) by adding the same number of registered embedding vectors Vr each time, the registration data 630(p) may be updated by adding a different number of registered embedding vectors Vr each time. That is, the number of registrations may be counted, and the registration data 630(p) may be updated so as to always include the registered embedding vectors Vr corresponding to q times of registration.

In step S220, the individual identification unit 530 determines whether there is a newly registered individual. The newly registered individual is an individual that is not registered in the registration data 630(p). Whether a newly registered individual is present is designated by the user. Alternatively, when a minimum value of the distance calculated for the identification target cow is equal to or greater than a predetermined threshold, it may be automatically determined that a newly registered individual is present. On this occasion, the individual ID of the newly registered individual may be input by the user. That is, the individual identification unit 530 may notify the user of the fact that the new individual is to be registered and prompt the user to input the individual ID. When there is no newly registered individual, the process proceeds to step S240 described later. On the other hand, when there is a newly registered individual, the process proceeds to step S230, and the individual identification unit 530 obtains N(p) embedding vectors regarding the newly registered individual and registers the embedding vectors in the registration data 630(p) in association with the individual ID. Here, N(p) may be a value equal to the number N1(p) of embedding vectors Vt for the identification target cow used in step S210, or may be a value equal to the number N2(p) of registered embedding vectors Vr for each of the registered individuals in the registration data 630(p). The processing in step S230 is substantially the same as the processing in steps S10, S20, S50, and S60 in FIG. 2 described above.

In step S240, the individual identification unit 530 determines whether there is an individual to be deleted from the registration data 630(p). Whether there is an individual to be deleted is designated by the user. When there is no individual to be deleted, the processing in FIG. 10 ends. On the other hand, when there is an individual to be deleted, the process proceeds to step S250, and the individual identification unit 530 deletes the data of that individual from the registration data 630(p). By executing the processing in FIG. 10, the registration data 630(p) can be maintained at the latest content.

According to the first embodiment described above, P types of embedding vectors Vt can be obtained from the target image TG related to the backside of the identification target cow using the P deep metric learning models 620(p), and an individual can be identified using P types of distances between the P types of embedding vectors Vt and the P types of registered embedding vectors Vr. Further, since the identification target cow is identified using the P types of target images TG captured using the P types of image sensors 400(p), the identification accuracy can be improved compared to when one type of imaging sensor is used.

### B. Second Embodiment

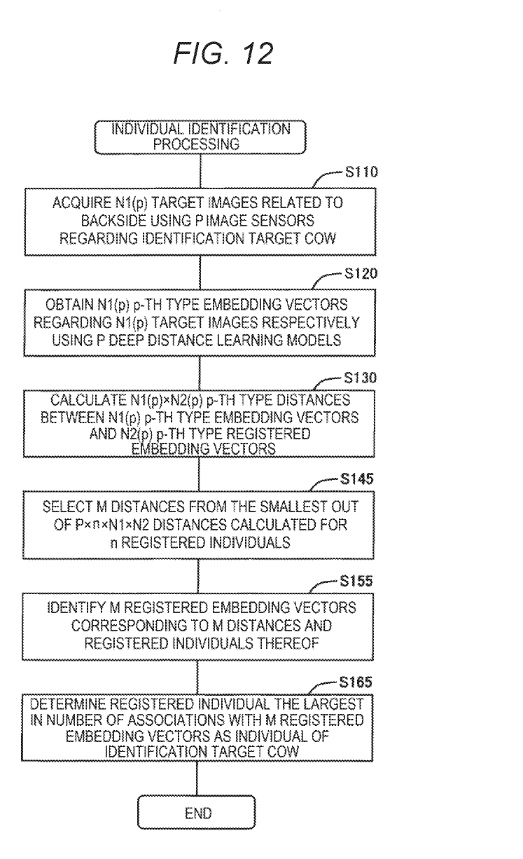

FIG. 12 is a flowchart showing a procedure of individual identification processing in a second embodiment. The second embodiment is the same as the first embodiment in a configuration of the apparatus and the processing contents in FIGS. 2 and 3. A processing procedure in FIG. 12 is obtained by replacing steps S140, S150, and S160 in FIG. 6 with steps S145, S155, and S165, and is the same as the processing procedure of the first embodiment in other steps.

In step S145, the individual identification unit 530 selects M distances from the smallest out of P×n×N1×N2 distances calculated for the n registered individuals. Here, an integer N1 is the number of target images TG similarly to the integer N1(p) used in the first embodiment, but is set to a constant value independent of the ordinal number p. Similarly to the integer N2(p) used in the first embodiment, an integer N2 is also the number of p-th type registered embedding vectors, but is set to a constant value independent of the ordinal number p. The character M denotes an integer no smaller than 2 and no greater than P×n×N1×N2, and is preferably an integer smaller than P×n×N1×N2. Further, the integers P, n, N1, and N2 are preferably set so that P×n×N1×N2 is no smaller than 3.

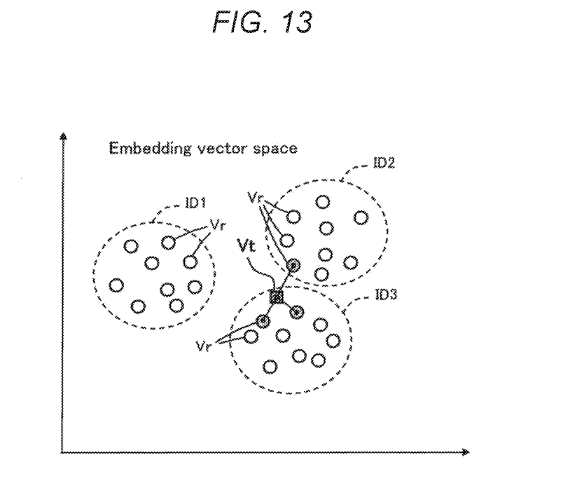

FIG. 13 shows the contents of distance calculation in the second embodiment, and shows an example in which n=3, N1=1, N2=9, and M=3 are set. The rectangle indicates a position of the embedding vector Vt obtained for the identification target cow, and hatched circles indicate M registered embedding vectors Vr each having a small distance from the embedding vector Vt of the identification target cow. In this example, since M=3 is set, three distances from the smallest are selected.

In step S155, the individual identification unit 530 identifies the M registered embedding vectors Vr corresponding to the M distances and the registered individuals thereof. In the example in FIG. 13, the individual ID related to two registered embedding vectors Vr corresponding to two distances among M (=3) distances is ID3, and the individual ID related to one registered embedding vector Vr corresponding to one distance is ID2.

In step S165, the individual identification unit 530 determines that the registered individual having the largest number of associations with the M registered embedding vectors Vr is the individual of the identification target cow. In the example in FIG. 13, the registered individual having the individual ID of ID3 is determined to be the individual of the identification target cow.

The second embodiment has substantially the same advantages as those of the first embodiment. Further, according to the processing in FIGS. 12 and 13 described above, the individual of the identification target cow can be determined using the smallest M distances among the P×n×N1×N2 distances related to the n registered individuals.

### C. Third Embodiment

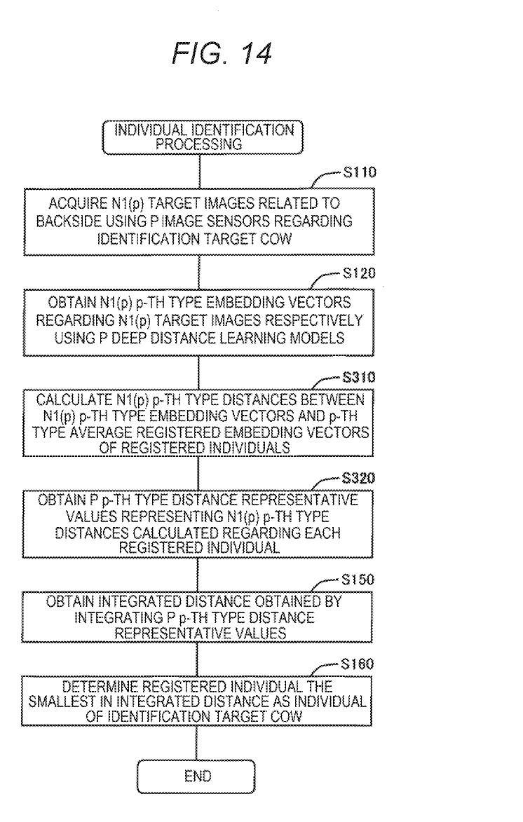

FIG. 14 is a flowchart showing a procedure of individual identification processing in a third embodiment. The third embodiment is the same as the first embodiment in a configuration of the apparatus and the processing contents in FIGS. 2 and 3. The processing procedure in FIG. 14 is obtained by replacing steps S130, S140 in FIG. 6 with steps S310, S320, and is the same as the processing procedure of the first embodiment in other steps.

In step S310 in FIG. 14, the individual identification unit 530 calculates N1(p) p-th type distances between the N1(p) p-th type embedding vectors obtained for the identification target cow and p-th type average registered embedding vector related to each of the registered individuals. The "p-th type average registered embedding vector" is an average vector of N2(p) p-th type registered embedding vectors Vr registered in the registration data 630(p).

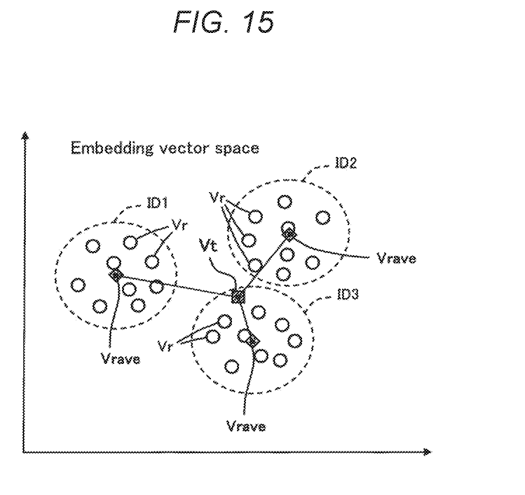

FIG. 15 shows the contents of the distance calculation in the third embodiment. The rhombuses each represent a p-th type average registered embedding vector Vrave related to each of the registered individuals. The p-th type average registered embedding vector Vrave can be calculated in advance before execution of step S310. Since the N1(p) p-th type embedding vectors are obtained for the identification target cow, n×N1(p) p-th type distances are calculated regarding the n registered individuals in step S310.

In step S320, the individual identification unit 530 obtains P p-th type distance representative values representing the N1(p) p-th type distances calculated for each of the registered individuals. As a method of obtaining the p-th type distance representative value, a method similar to the determination methods DM1 and DM2 described in the first embodiment can be used. The processing in steps S150, S160 is the same as that of the first embodiment shown in FIG. 6.

The third embodiment has substantially the same advantages as those of the first embodiment. Further, according to the individual identification processing of the third embodiment, since the number of times of the distance calculation is small, the processing speed can be increased.

### D. Fourth Embodiment

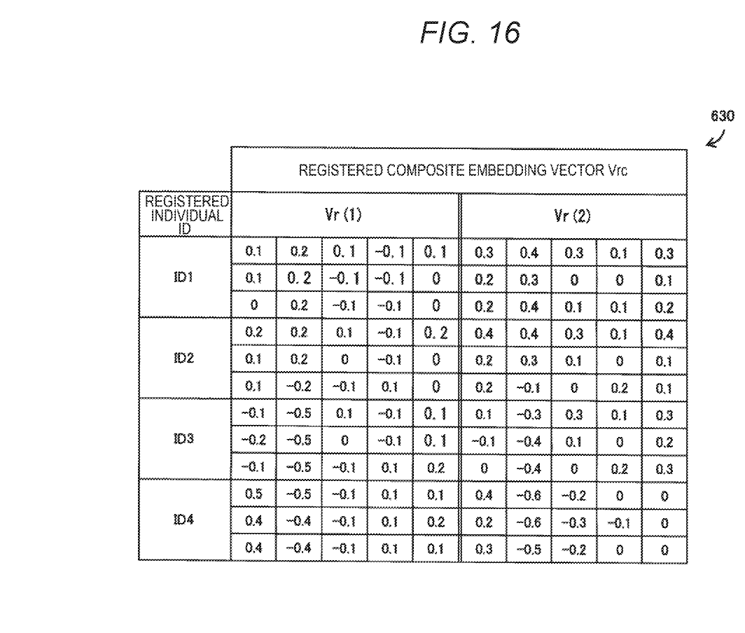

FIG. 16 is a diagram illustrating an example of the registration data 630 in a fourth embodiment. The fourth embodiment is substantially the same as the first embodiment in a configuration of the apparatus and the processing contents in FIGS. 2 and 3.

In the fourth embodiment, instead of individually registering the P registered embedding vectors Vr(p) generated using the P image sensors 400(p) in the P registration data 630(p), a registration composite embedding vector Vrc obtained by combining the P registered embedding vectors Vr(p) is registered in a single registration datum 630. The registered composite embedding vector Vrc shown in FIG. 16 is a combination of the two registered embedding vectors Vr(1), Vr(2) illustrated in FIG. 5, and is a 10-dimensional vector configured with 10 elements. In the registration datum 630, the individual ID of each of the registered individuals and a plurality of registered composite embedding vectors Vrc for each of the registered individuals are registered.

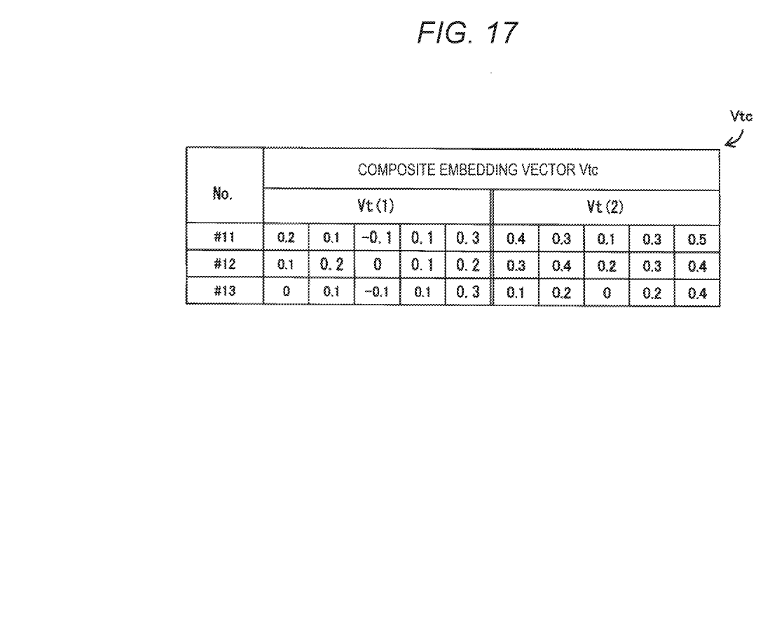

FIG. 17 is a diagram illustrating an example of a composite embedding vector used in the fourth embodiment. In the individual identification processing in the fourth embodiment, a composite embedding vector Vtc obtained by combining P embedding vectors Vt(p) is also used as the embedding vector obtained for the identification target cow. The composite embedding vector Vtc in FIG. 17 is a combination of two embedding vectors Vt(1), Vt(2) illustrated in FIG. 7, and is a 10-dimensional vector configured with 10 elements. When obtaining the composite embedding vector Vtc, it is preferable to obtain the P embedding vectors Vt(p) using P target images captured at the same timing by the P image sensors 400(p). The same applies to when obtaining the registered composite embedding vector Vrc.

As described below, as the individual identification processing using the registered composite embedding vector Vrc and the composite embedding vector Vtc, it is possible to apply processing according to the first to third embodiments described above.

### D1. Processing Example of Fourth Embodiment According to First Embodiment

When performing the individual identification according to the first embodiment using the registered composite embedding vector Vrc and the composite embedding vector Vtc, processing can be executed in the following procedure.

### Processing S11

When defining P as an integer no smaller than 2, p as an ordinal number from 1 to P, and N1 as an integer no smaller than 1, N1 p-th type target images are acquired related to the same identification target cow. The integer N1 is set to a value independent of the ordinal number p.

### Processing S12

N1 composite embedding vectors Vtc are generated by obtaining N1 p-th type embedding vectors Vt(p) for the N1 p-th type target images using the P p-th deep metric learning models 620(p), and combining P p-th type embedding vectors Vt(p).

### Processing S13

Defining N2 as an integer no smaller than 2, N1×N2 distances between N2 registered composite embedding vectors Vrc and the N1 composite embedding vectors Vtc related to each of the plurality of registered individuals are calculated. The integer N2 is set to a value independent of the ordinal number p.

### Processing S14

From the N1×N2 distances related to each of the plurality of registered individuals, which one of the plurality of registered individuals is the identification target cow is determined.

In the individual identification processing according to the first embodiment, it is preferable to further execute the processing S14 described above in such a manner as follows.

### Processing S14-11

Defining M as an integer no smaller than 2 and no greater than N1×N2, a distance representative value representing N1×N2 distances is obtained for each of the plurality of registered individuals.

### Processing S14-12

The registered individual the smallest in distance representative value out of the plurality of registered individuals is determined as the individual of the identification target cow.

In the processing of the fourth embodiment according to the first embodiment, it is possible to determine which one of the plurality of registered individuals is the identification target cow using the N1×N2 distances related to each of the plurality of registered individuals. In addition, it is possible to determine the individual of the identification target cow from a distance average value representing the N1×N2 distances related to each of the registered individuals.

### D2. Processing Example of Fourth Embodiment According to Second Embodiment

When the individual identification is performed according to the second embodiment using the registered composite embedding vector Vrc and the composite embedding vector Vtc, it is preferable to execute the processing S11 to S14 described above and execute the processing S14 in the following procedure.

### Processing S14-21

Defining n as the number of registered individuals and M as an integer no smaller than 2 and no greater than n×N1×N2, the M distances are selected from the smallest out of n×N1×N2 distances obtained regarding the n registered individuals. The integers M, N1, and N2 are set to values independent of the ordinal number p.

### Processing S14-22

The M registered composite embedding vectors Vrc corresponding to the M distances are identified, and the registered individuals associated respectively with the M registered composite embedding vectors Vrc are identified.

### Processing S14-23

The registered individual the largest in number of associations with the M registered composite embedding vectors Vrc out of the n registered individuals is determined as the individual of the identification target cow.

In the processing of the fourth embodiment according to the second embodiment, the individual of the identification target cow can be determined using the smallest M distances out of the n×N1×N2 distances related to the n registered individuals.

### D3. Processing Example of Fourth Embodiment According to Third Embodiment

When the individual identification is performed according to the third embodiment using the registered composite embedding vectors Vrc and the composite embedding vectors Vtc, the processing can be executed in the following procedure.

### Processing S31

Defining N1 as an integer no smaller than 1, the N1 composite embedding vectors Vtc for the N1 target images are obtained. The integer N1 is set to a value independent of the ordinal number p.

### Processing S32

N1 distances between the N1 composite embedding vectors Vtc and an average registered composite embedding vector that is an average of the registered composite embedding vectors Vrc related to each the plurality of registered individuals are calculated.

### Processing S33

A distance representative value representing the N1 distances related to each of the plurality of registered individuals is obtained.

### Processing S34

The registered individual the smallest in distance representative value is determined to be the individual of the identification target cow.

In the processing of the fourth embodiment according to the third embodiment, since the small number of times of distance calculation is sufficient, the processing speed can be increased.

The fourth embodiment has substantially the same advantages as those of the first to third embodiments described above. Further, in the fourth embodiment, the individual can be identified using the distances between the registered composite embedding vectors Vrc and the composite embedding vectors Vtc.

### E. Fifth Embodiment

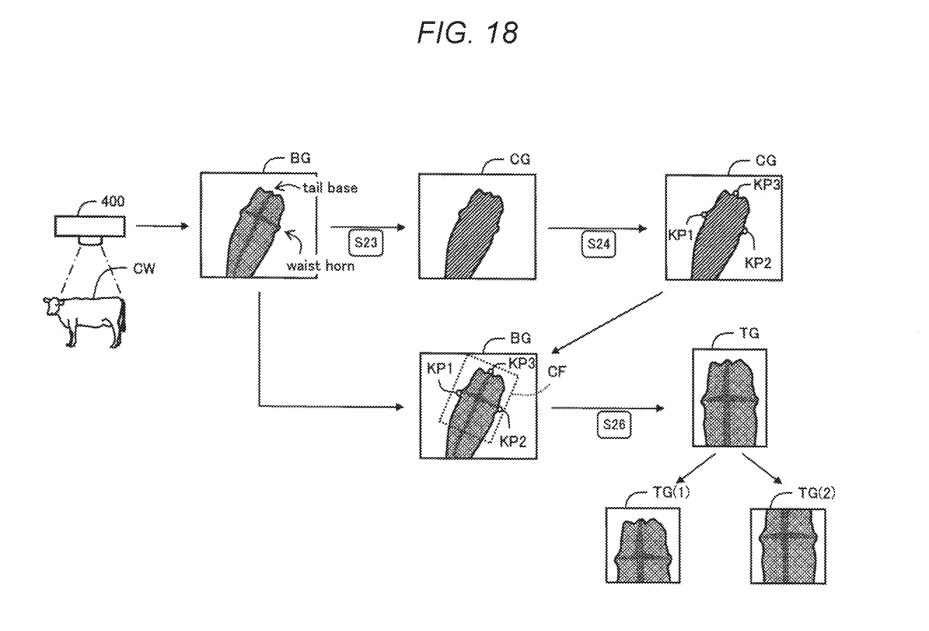

FIG. 18 is a diagram illustrating the contents of target image generation processing in a fifth embodiment. The fifth embodiment is substantially the same as the first embodiment in a configuration of the apparatus and the processing contents in FIGS. 2 and 3.

In the fifth embodiment, the target images TG are generated using a single image sensor 400, and P target images TG(p) are generated by dividing each of the target images TG into P parts. In the example in FIG. 18, P=2 is assumed, and two target images TG(1) and TG(2) are generated from one target image TG. The P target images TG(p) may partially overlap each other or may be divided so as not to overlap each other. Such a method of generating the target images TG(p) by division is applied at the time of generation of the learning data for the deep metric learning model 620(p), generation of the registration data 630(p), and generation of the embedding vectors for the identification target cow. The number of image sensors 400 used in the fifth embodiment is one.

As the individual identification processing in the fifth embodiment, the individual identification processing described in the first to fourth embodiments described above can be applied. In the fifth embodiment, since the identification target cow is identified using P types of target images TG(p) obtained by dividing the image captured using the same image sensor 400, the identification accuracy can be improved compared to when using a single type of target image TG.

Note that in the first to fifth embodiments described above, the target image related to the backside of the animal is generated, and learning of the deep metric learning model 620(p) for backside learning is performed using that target image, but in addition to this, a target image including a face of the animal may be generated, and a deep metric learning model for face learning may be learned using that target image. In this case, the individual identification can be performed using an integrated distance of a distance calculated using the deep metric learning model 620(p) for backside learning and a distance calculated using the deep metric learning model for face learning. In this method, the individual identification can be performed more accurately.

### Other Aspects

The present disclosure is not limited to the embodiments described above, and can be implemented in various forms without departing from the spirit of the present disclosure. For example, the present disclosure can be implemented by the following aspects. The technical features in the embodiments described above corresponding to the technical features in the aspects described below can be replaced or combined as appropriate in order to solve a part or all of the problems of the present disclosure, or to achieve a part or all of the advantages of the present disclosure. Further, any of the technical features can be eliminated as appropriate unless described as essential in the present specification.

(1) According to a first aspect of the present disclosure, a method of performing individual identification of an identification target animal is provided. This method includes: (a) acquiring P types of p-th type target images from a first type target image to a P-th type target image with respect to a backside of the identification target animal, where P is an integer no smaller than 2, and p is an ordinal number from 1 to P; (b) obtaining P types of p-th type embedding vectors by obtaining the p-th type embedding vectors from the p-th type target images using a p-th deep metric learning model out of P deep metric learning models; (c) calculating distances between P types of p-th type registered embedding vectors and the P types of p-th type embedding vectors using registration data including the P types of p-th type registered embedding vectors generated in advance with respect to each of a plurality of registered individuals; and (d) determining which of the plurality of registered individuals is the identification target animal using the distances.

According to this method, the P types of p-th type embedding vectors can be obtained from the P types of p-th type target images related to the backside of the identification target animal using the P deep metric learning models, and the individual can be identified using the distances between the P types of p-th type embedding vectors and the P types of p-th type registered embedding vectors.

(2) In the method described above, the P types of p-th type target images may be images generated from captured images obtained by capturing the backside of the identification target animal using P types of image sensors, respectively.

According to this method, since the identification target animal is identified using the P types of p-th type target images captured using the P types of image sensors, the identification accuracy can be improved compared to when using the image sensor of one type.

(3) In the method described above, the P types of image sensors may include a depth sensor and an RGB sensor, and the step (a) may include (a1) acquiring a depth image and a color image related to the backside of the identification target animal using the depth sensor and the RGB sensor, (a2) detecting a plurality of key points from at least one of the depth image and the color image using an object recognition model, (a3) generating a first type target image by clipping a characterizing portion of the backside from the depth image with reference to positions of the plurality of key points, and (a4) generating a second type target image by clipping the characterizing portion of the backside from the color image with reference to the positions of the plurality of key points.

According to this method, the target image including the characterizing portion of the backside can be acquired from the depth image and the color image.

(4) In the method described above, N1(p) may be an integer no smaller than 1 and defined with respect to the ordinal number p, and N2(p) may be an integer no smaller than 2 and defined with respect to the ordinal number p. The step (a) may include acquiring N1(p) p-th type target images each identical to the p-th type target image with respect to the same identification target animal, the step (b) may include obtaining N1(p) p-th type embedding vectors each identical to the p-th type embedding vector with respect to the N1(p) p-th type target images using the p-th deep metric learning model, the step (c) may include calculating N1(p)×N2(p) p-th type distances between N2(p) p-th type registered embedding vectors each identical to the p-th type registered embedding vector and N1(p) p-th type embedding vectors each identical to the p-th type embedding vector with respect to each of the plurality of registered individuals, and the step (d) may include determining which of the plurality of registered individuals is the identification target animal from the N1(p)×N2(p) p-th type distances related to each of the plurality of registered individuals.

According to this method, it is possible to determine which of the plurality of registered individuals is the identification target animal using the N1(p)×N2(p) p-th type distances related to each of the plurality of registered individuals.

(5) In the method described above, the step (d) may include (d1) obtaining a p-th type distance representative value representing the N1(p)×N2(p) p-th type distances with respect to each of the plurality of registered individuals, (d2) obtaining an integrated distance obtained by integrating P p-th type distance representative values each identical to the p-th type distance representative value, and (d3) determining that the registered individual smallest in integrated distance out of the plurality of registered individuals is an individual of the identification target animal.

According to this method, the individual of the identification target animal can be determined from the integrated distance related to each of the registered individuals.

(6) In the method described above, the integers N1(p), N2(p) may be integers N1, N2 independent of the ordinal number p, respectively, n may be the number of registered individuals, and M may be an integer no smaller than 2 and no greater than P×n×N1×N2. The step (d) may include (d1) selecting M p-th type distances from a smallest out of the P×n×N1×N2 p-th type distances each identical to the p-th type distance and obtained with respect to the n registered individuals, (d2) identifying M registered embedding vectors corresponding to the M p-type distances, and identifying the registered individuals respectively associated with the M registered embedding vectors, and (d3) determining that the registered individual largest in number of associations with the M registered embedding vectors out of the n registered individuals is an individual of the identification target animal.

According to this method, the individual of the identification target animal can be determined using the smallest M distances out of the P×n×N1×N2 p-th type distances related to the n registered individuals.

(7) In the method described above, N1(p) may be an integer no smaller than 1 and defined with respect to the ordinal number p. The step (b) may include obtaining N1(p) p-th type embedding vectors each identical to the p-th type embedding vector with respect to N1(p) p-th type target images each identical to the p-th type target image, and the step (c) may include calculating N1(p) p-th type distances between a p-th type average registered embedding vector obtained by averaging the p-th type registered embedding vectors and the N1(p) p-th type embedding vectors with respect to each of the plurality of registered individuals. The step (d) may include (d1) obtaining a p-th type distance representative value representing the N1(p) p-th type distances with respect to each of the plurality of registered individuals, (d2) obtaining an integrated distance obtained by integrating P p-th type distance representative values each identical to the p-th type distance representative value, and (d3) determining that the registered individual smallest in integrated distance out of the plurality of registered individuals is an individual of the identification target animal.

According to this method, since a small number of times of distance calculation is sufficient, the processing speed can be increased.

(8) In the above method, the step (c) may include calculating a distance between a registered composite embedding vector obtained by combining the P types of p-th type registered embedding vectors and a composite embedding vector obtained by combining the P types of p-th type embedding vectors.

According to this method, the individual can be identified using the distance between the registered composite embedding vector and the composite embedding vector.

(9) In the method described above, N1 may be an integer no smaller than 1, and N2 may be an integer no smaller than 2. The step (a) may include acquiring N1 p-th type target images each identical to the p-th type target image with respect to the same identification target animal, the step (b) may include obtaining N1 p-th type embedding vectors each identical to the p-th type embedding vector with respect to the N1 p-th type target images using the p-th deep metric learning model, and generating N1 composite embedding vectors by combining P p-th type embedding vectors each identical to the p-th type embedding vector, the step (c) may include calculating N1×N2 distances between N2 registered composite embedding vectors each identical to the registered composite embedding vector and the N1 composite embedding vectors with respect to each of the plurality of registered individuals, and the step (d) may include determining which of the plurality of registered individuals is the identification target animal from the N1×N2 distances with respect to each of the plurality of registered individuals.

According to this method, it is possible to determine which of the plurality of registered individuals is the identification target animal using the N1×N2 distances related to each of the plurality of registered individuals.

(10) In the method described above, M may be an integer no smaller than 2 and no greater than N1×N2. The step (d) may include (d1) obtaining a distance representative value representing the N1×N2 distances with respect to each of the plurality of registered individuals, and (d2) determining that the registered individual smallest in distance representative value out of the plurality of registered individuals is an individual of the identification target animal.

According to this method, the individual of the identification target animal can be determined from the distance representative value representing the N1×N2 distances related to each of the registered individuals.

(11) In the method described above, n may be the number of registered individuals, and M may be an integer no smaller than 2 and no greater than n×N1×N2. The step (d) may include (d1) selecting M distances from a smallest out of n×N1×N2 distances each identical to the distance and obtained with respect to the n registered individuals, (d2) identifying M registered composite embedding vectors corresponding to the M distances, and identifying the registered individuals respectively associated with the M registered composite embedding vectors, and (d3) determining that the registered individual largest in number of associations with the M registered composite embedding vectors out of the n registered individuals is an individual of the identification target animal.

According to this method, the individual of the identification target animal can be determined using the smallest M distances out of the n×N1×N2 distances related to the n registered individuals.

(12) In the method described above, N1 may be an integer no smaller than 1. The step (b) may include obtaining the N1 composite embedding vectors with respect to the N1 p-th type target images, and the step (c) may include calculating N1 distances between an average registered composite embedding vector obtained by averaging the registered composite embedding vectors and the N1 composite embedding vectors with respect to each of the plurality of registered individuals. The step (d) may include (d1) obtaining a distance representative value representing the N1 distances with respect to each of the plurality of registered individuals, and (d2) determining that the registered individual smallest in distance representative value out of the plurality of registered individuals is an individual of the identification target animal.

According to this method, since a small number of times of distance calculation is sufficient, the processing speed can be increased.

(13) In the method described above, the P types of p-th type target images may be divisional images obtained by dividing an image obtained by capturing the backside of the identification target animal using a same image sensor into P types.

According to this method, since the identification target animal is identified using the P types of target images obtained by dividing the image captured using the same image sensor, the identification accuracy can be improved compared to when using target image of one type.

(14) According to a second aspect of the present disclosure, there is provided a non-transitory computer-readable storage medium storing a computer program configured to make a processor execute processing of individual identification of an identification target animal. This computer program makes the processor execute the processing including: (a) acquiring P types of p-th type target images from a first type target image to a P-th type target image with respect to a backside of the identification target animal, where P is an integer no smaller than 2, and p is an ordinal number from 1 to P; (b) obtaining P types of p-th type embedding vectors by obtaining the p-th type embedding vectors from the p-th type target images using a p-th deep metric learning model out of P deep metric learning models; (c) calculating distances between P types of p-th type registered embedding vectors and the P types of p-th type embedding vectors using registration data including the P types of p-th type registered embedding vectors generated in advance with respect to each of a plurality of registered individuals; and (d) determining which of the plurality of registered individuals is the identification target animal using the distances.

The present disclosure can be implemented in various forms other than the above. For example, the present disclosure can be implemented in the form of an apparatus that realizes the individual identification processing or a non-transitory storage medium storing the computer program.

What is claimed is:

1. A method of individual identification of an identification target animal, the method comprising:
(a) acquiring P types of p-th type target images from a first type target image to a P-th type target image with respect to a backside of the identification target animal, where P is an integer no smaller than 2, and p is an ordinal number from 1 to P;
(b) obtaining P types of p-th type embedding vectors by obtaining the p-th type embedding vectors from the p-th type target images using a p-th deep metric learning model out of P deep metric learning models;
(c) calculating distances between P types of p-th type registered embedding vectors and the P types of p-th type embedding vectors using registration data including the P types of p-th type registered embedding vectors generated in advance with respect to each of a plurality of registered individuals; and
(d) determining which of the plurality of registered individuals is the identification target animal using the distances.

2. The method according to claim 1, wherein
the P types of p-th type target images are images generated from captured images obtained by capturing the backside of the identification target animal using P types of image sensors, respectively.

3. The method according to claim 2, wherein
the P types of image sensors include a depth sensor and an RGB sensor, and
the step (a) includes
(a1) acquiring a depth image and a color image related to the backside of the identification target animal using the depth sensor and the RGB sensor,
(a2) detecting a plurality of key points from at least one of the depth image and the color image using an object recognition model,
(a3) generating a first type target image by clipping a characterizing portion of the backside from the depth image with reference to positions of the plurality of key points, and
(a4) generating a second type target image by clipping the characterizing portion of the backside from the color image with reference to the positions of the plurality of key points.

4. The method according to claim 1, wherein
defining N1(p) as an integer which is defined with respect to the ordinal number p and is equal to or greater than 1, and N2(p) as an integer which is defined with respect to the ordinal number p and is equal to or greater than 2,
the step (a) includes acquiring N1(p) p-th type target images each identical to the p-th type target image with respect to the same identification target animal,
the step (b) includes obtaining N1(p) p-th type embedding vectors each identical to the p-th type embedding vector with respect to the N1(p) p-th type target images using the p-th deep metric learning model,
the step (c) includes calculating N1(p)×N2(p) p-th type distances between N2(p) p-th type registered embedding vectors each identical to the p-th type registered embedding vector and N1(p) p-th type embedding vectors each identical to the p-th type embedding vector with respect to each of the plurality of registered individuals, and
the step (d) includes determining which of the plurality of registered individuals is the identification target animal from the N1(p)×N2(p) p-th type distances related to each of the plurality of registered individuals.

5. The method according to claim 4, wherein
the step (d) includes
(d1) obtaining a p-th type distance representative value representing the N1(p)×N2(p) p-th type distances with respect to each of the plurality of registered individuals,
(d2) obtaining an integrated distance obtained by integrating P p-th type distance representative values each identical to the p-th type distance representative value, and
(d3) determining that the registered individual smallest in integrated distance out of the plurality of registered individuals is an individual of the identification target animal.

6. The method according to claim 4, wherein
defining the integers N1(p), N2(p) as integers N1, N2 independent of the ordinal number p, respectively,
n as a number of the registered individuals, and M as an integer no smaller than 2 and no greater than P×n×N1×N2,
the step (d) includes
(d1) selecting M p-th type distances from a smallest out of P×n×N1×N2 p-th type distances each identical to the p-th type distance and obtained with respect to the n registered individuals,
(d2) identifying M registered embedding vectors each identical to the registered embedding vector and corresponding to the M p-th type distances, and identifying the registered individuals respectively associated with the M registered embedding vectors, and
(d3) determining that the registered individual largest in number of associations with the M registered embedding vectors out of the n registered individuals is an individual of the identification target animal.

7. The method according to claim 1, wherein
defining N1(p) as an integer which is defined with respect to the ordinal number p and is equal to or greater than 1,
the step (b) includes obtaining N1(p) p-th type embedding vectors each identical to the p-th type embedding vector with respect to N1(p) p-th type target images each identical to the p-th type target image,
the step (c) includes calculating N1(p) p-th type distances between a p-th type average registered embedding vector obtained by averaging the p-th type registered embedding vectors and the N1(p) p-th type embedding vectors with respect to each of the plurality of registered individuals, and
the step (d) includes
(d1) obtaining a p-th type distance representative value representing the N1(p) p-th type distances with respect to each of the plurality of registered individuals,
(d2) obtaining an integrated distance obtained by integrating P p-th type distance representative values each identical to the p-th type distance representative value, and
(d3) determining that the registered individual smallest in integrated distance out of the plurality of registered individuals is an individual of the identification target animal.

8. The method according to claim 1, wherein
the step (c) includes calculating a distance between a registered composite embedding vector obtained by combining the P types of p-th type registered embedding vectors and a composite embedding vector obtained by combining the P types of p-th type embedding vectors.

9. The method according to claim 8, wherein
defining N1 as an integer no smaller than 1, and N2 as an integer no smaller than 2,
the step (a) includes acquiring N1 p-th type target images each identical to the p-th type target image with respect to the same identification target animal,
the step (b) includes obtaining N1 p-th type embedding vectors each identical to the p-th type embedding vector with respect to the N1 p-th type target images using the p-th deep metric learning model, and generating N1 composite embedding vectors by combining P p-th type embedding vectors each identical to the p-th type embedding vector,
the step (c) includes calculating N1×N2 distances between N2 registered composite embedding vectors each identical to the registered composite embedding vector and the N1 composite embedding vectors with respect to each of the plurality of registered individuals, and
the step (d) includes determining which of the plurality of registered individuals is the identification target animal from the N1×N2 distances with respect to each of the plurality of registered individuals.

10. The method according to claim 9, wherein
defining M as an integer no smaller than 2 and no greater than N1×N2,
the step (d) includes
(d1) obtaining a distance representative value representing the N1×N2 distances with respect to each of the plurality of registered individuals, and
(d2) determining that the registered individual smallest in distance representative value out of the plurality of registered individuals is an individual of the identification target animal.

11. The method according to claim 9, wherein
defining n as a number of the registered individuals, and M as an integer no smaller than 2 and no greater than n×N1×N2,
the step (d) includes
(d1) selecting M distances from a smallest out of the n×N1×N2 distances each identical to the distance and obtained with respect to the n registered individuals,
(d2) identifying M registered composite embedding vectors corresponding to the M distances, and identifying the registered individuals respectively associated with the M registered composite embedding vectors, and
(d3) determining that the registered individual largest in number of associations with the M registered composite embedding vectors out of the n registered individuals is an individual of the identification target animal.

12. The method according to claim 8, wherein
defining N1 as an integer no smaller than 1,
the step (b) includes obtaining N1 composite embedding vectors with respect to N1 p-th type target images,
the step (c) includes calculating N1 distances between an average registered composite embedding vector obtained by averaging the registered composite embedding vectors and the N1 composite embedding vectors with respect to each of the plurality of registered individuals, and
the step (d) includes
(d1) obtaining a distance representative value representing the N1 distances with respect to each of the plurality of registered individuals, and
(d2) determining that the registered individual smallest in distance representative value out of the plurality of registered individuals is an individual of the identification target animal.

13. The method according to claim 1, wherein
the P types of p-th type target images are divisional images obtained by dividing an image obtained by capturing the backside of the identification target animal using a same image sensor into P types.

14. A non-transitory computer-readable storage medium storing a computer program configured to make a processor execute processing of individual identification of an identification target animal, the processing comprising:
(a) acquiring P types of p-th type target images from a first type target image to a P-th type target image with respect to a backside of the identification target animal, where P is an integer no smaller than 2, and p is an ordinal number from 1 to P;
(b) obtaining P types of p-th type embedding vectors by obtaining the p-th type embedding vectors from the p-th type target images using a p-th deep metric learning model out of P deep metric learning models;
(c) calculating distances between P types of p-th type registered embedding vectors and the P types of p-th type embedding vectors using registration data including the P types of p-th type registered embedding vectors generated in advance with respect to each of a plurality of registered individuals; and
(d) determining which of the plurality of registered individuals is the identification target animal using the distances.
